(19) United States
(12) Patent Application Publication
(10) Pub. No.: US 2016/0070414 A1
(43) Pub. Date: Mar. 10, 2016

(54) Electronic Devices With Replaceable Subassemblies

(71) Applicant: Apple Inc., Cupertino, CA (US)

(72) Inventors: Ashutosh Y. Shukla, Santa Clara, CA (US); Bingrui Yang, Cupertino, CA (US); David A. Pakula, San Francisco, CA (US); David Stronks, San Jose, CA (US)

(21) Appl. No.: 14/846,354

(22) Filed: Sep. 4, 2015

Related U.S. Application Data
(60) Provisional application No. 62/046,798, filed on Sep. 5, 2014.

(51) Int. Cl. G06F 3/041; G06K 9/00

(52) U.S. Cl. CPC G06F 3/0418; G06K 9/00006; G06F 3/0412; G06F 2203/04101

(57) ABSTRACT

An electronic device may include electrical components. The electrical components may be calibrated. Calibration data may be stored in non-volatile memory on a component assembly or may be stored in a remote databased while a subassembly identifier is stored in the non-volatile memory. If a subassembly in a device becomes damaged, a replacement subassembly may be installed in the device. Control circuitry in the device may retrieve calibration data for the replacement subassembly from non-volatile memory on the subassembly or from the remote database.

This application claims priority to U.S. provisional patent application No. 62/046,798, filed Sep. 5, 2014, which is hereby incorporated by reference herein in its entirety.

### BACKGROUND

This relates generally to electronic devices, and, more particularly, to electronic devices that include components that may be replaced during servicing.

Electronic devices include electronic components such as displays and sensors. Components such as these may become damaged during use of an electronic device. For example, a user may crack a display by inadvertently dropping a device on a hard surface.

Challenges can arise when repairing an electronic device. Components such as displays and associated components that may be included in a display subassembly may benefit from calibration. Factory test equipment may be available to calibrate a device with a replacement display or other such repair, but it can be inconvenient to require a user to return a repaired device to a factory for servicing. Repairs handled without performing proper calibration operations may result in devices that do not perform as well as expected.

It would therefore be desirable to be able to provide improved techniques for providing electronic devices with calibrated repairs.

### SUMMARY

An electronic device may include electrical components. The electrical components may be calibrated. Calibration data may be stored in non-volatile memory on a component assembly or may be stored in a remote database while a subassembly identifier that can be used to retrieve the calibration data from the database is stored in the non-volatile memory. If a subassembly in a device becomes damaged, a replacement subassembly may be installed in the device. Control circuitry in the device may retrieve calibration data for the replacement subassembly from non-volatile memory on the subassembly or from the remote database.

The subassemblies in a device may include components that are mounted to common support structures or printed circuit. For example, a display subassembly may be formed from electrical components mounted to a display cover layer. The display cover layer may be a transparent layer of material that forms one of the layers of the display or that serves as a separate protective layer. Components that may be attached to the display cover layer include a display module (e.g., display layers containing a pixel array and an integrated display touch sensor), an ambient light sensor, a proximity sensor, and a fingerprint sensor.

### BRIEF DESCRIPTION OF THE DRAWINGS

FIG. 1 is a perspective view of an illustrative electronic device in accordance with an embodiment.

FIG. 2 is a cross-sectional side view of an illustrative electronic device in accordance with an embodiment.

FIG. 3 is a diagram of illustrative equipment for calibrating electronic device components such as subassemblies in accordance with an embodiment.

FIG. 4 is a diagram of illustrative equipment for repairing an electronic device in accordance with an embodiment.

FIG. 5 is a flow chart of illustrative steps involved in performing calibration and repair operations in accordance with an embodiment.

### DETAILED DESCRIPTION

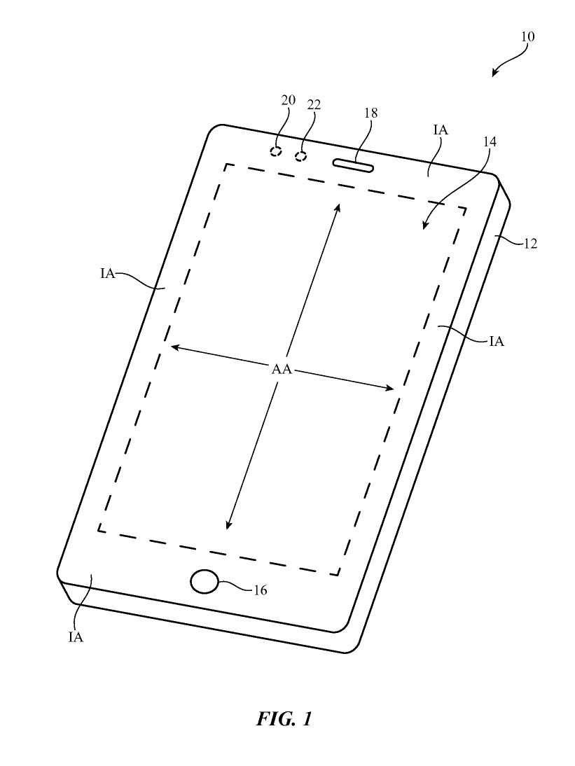

An electronic device such as electronic device 10 of FIG. 1 may contain electrical components. The electrical components may be joined into subassemblies that are combined to create a finished device. When repairs are needed, a broken subassembly can be replaced with a replacement subassembly. The replacement subassembly may be provided with non-volatile memory that stores calibration data for retrieval and use by control circuitry within the electronic device. If desired, calibration data may also be retrieved from remote storage using a subassembly identifier that is stored on the replacement subassembly.

Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. In the illustrative configuration of FIG. 1, device 10 is a portable device such as a cellular telephone, media player, tablet computer, or other portable computing device. Other configurations may be used for device 10 if desired. The example of FIG. 1 is merely illustrative.

In the example of FIG. 1, device 10 includes a display such as display 14 mounted in housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode display pixels or other light-emitting diodes, an array of electrowetting display pixels, or display pixels based on other display technologies.

Display 14 may be protected using a display cover layer such as a layer of transparent glass or clear plastic. Openings may be formed in the display cover layer. For example, an opening may be formed in the display cover layer to accommodate a button such as button 16. An opening may also be formed in the display cover layer to accommodate ports such as speaker port 18. Openings may be formed in housing 12 to form communications ports (e.g., an audio jack port, a digital data port, etc.), to form openings for buttons, etc.

Display 14 may have an active area such as active area AA and an inactive border such as inactive area IA. A display module or other display structures containing an array of pixels may be mounted in active area AA to display images for a user. The display module may include display layers for producing images and an integral display touch sensor. The underside of the display cover layer in inactive area IA may be covered with ink or other opaque masking material to hide internal device components from view. Optical windows may be formed in the opaque masking layer in regions such as regions 20 and 22. The optical windows may be used to allow visible and/or infrared light to pass through the opaque masking layer. Sensors may be mounted in alignment with the windows. For example, an ambient light sensor may be mounted under a window in region 20 and a light-based proximity sensor may be mounted under a window in region 22. Device 10 may also have a fingerprint sensor (e.g., a fingerprint sensor that is integrated with button 16), may have buttons, and may have other components.

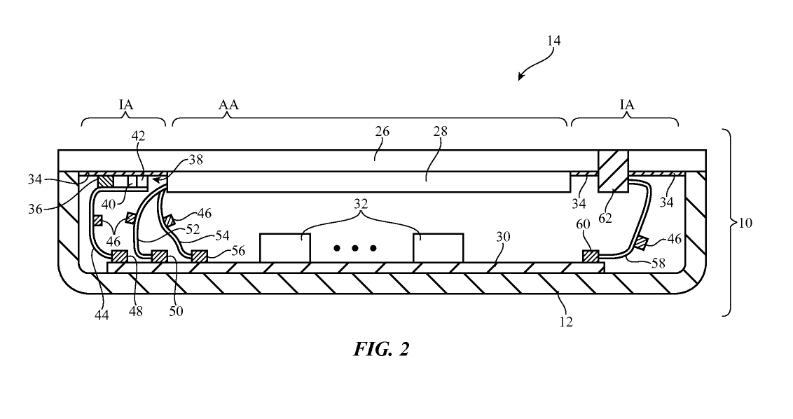

A cross-sectional side view of electronic device 10 of FIG. 1 is shown in FIG. 2. As shown in FIG. 2, display 14 of device 10 may be formed from a display module such as display module 28 mounted under a cover layer such as display cover layer 26 (as an example). Display cover layer 26 may form the outermost layer in a stack of display layers (e.g., a color filter layer or thin-film transistor layer) or may serve as a separate protective layer for display 14.

Display 14 (display module 28) may be a liquid crystal display, an organic light-emitting diode display, a plasma display, an electrophoretic display, a display that is insensitive to touch, a touch sensitive display that incorporates and array of capacitive touch sensor electrodes or other touch sensor structures, or may be any other type of suitable display. Display cover layer 26 (or other layer that serves as the outermost layer in display 14) may be layer of clear glass, a transparent plastic member, a transparent crystalline member such as a sapphire layer, a clear layer that incorporates multiple layers such as these, or other clear structure.

Device 10 may have inner housing structures that provide additional structural support to device 10 and/or that serve as mounting platforms for printed circuits and other structures. Structural internal housing members may sometimes be referred to as housing structures and may be considered to form part of housing 12.

Electrical components 32 may be mounted within the interior of housing 12. Components 32 may be mounted to one or more printed circuits such as printed circuit 30 (sometimes referred to as a main logic board or motherboard). Components 32 may include integrated circuits, memory, and other storage and processing circuitry that serves as the control circuitry for device 10. During operation, this control circuitry may execute software to provide device 10 with the ability to handle communications with external devices, gather input from a user, provide output to the user, implement calibration operations based on calibration data, etc.

Printed circuit 30 may be a rigid printed circuit board (e.g., a printed circuit board formed from fiberglass-filled epoxy or other rigid printed circuit board material) or may be a flexible printed circuit (e.g., printed circuit formed from a sheet of polyimide or other flexible polymer layer). Patterned metal traces within printed circuit board 30 may be used to form signal paths between components 32. If desired, components such as connectors may be mounted to printed circuit 30. As shown in FIG. 2, for example, a cable such as flexible printed circuit 44 may couple sensors such as ambient light sensor 36 and proximity sensor 38 to printed circuit 30 using connector 48. A flexible printed circuit cable such as flexible printed circuit 52 may couple a touch sensor such as a capacitive touch sensor in module 28 to printed circuit 30 using connector 50. A cable such as flexible printed circuit cable 54 may be used to couple display module 28 to printed circuit 30 using connector 56. A component such as fingerprint sensor 62 (with or without an integral button) may be coupled to printed circuit 30 using flexible printed circuit cable 58 and connector 60.

Display module 28 may display images for a user in active area AA of display 14. The inner surface of display cover layer 26 may be covered with opaque masking layer 34. Ambient light sensor 36 may be mounted on the underside of display cover layer 26 in alignment with an optical window in opaque masking layer 34 that passes visible light. Proximity sensor 38 may be mounted on the underside of display cover layer 26 in alignment with an optical window in opaque masking layer 34 that passes infrared light. During operation, light source 40 of proximity sensor 38 may emit light and light detector 42 of proximity sensor 38 may detect emitted light that has been reflected from a nearby object. Light source 40 may be an infrared light-emitting diode and light detector 42 may be a light sensor that is sensitive to infrared light (as an example).

The components of device 10 may sometimes be mounted together on a common printed circuit or other support structure. In this way, some of these components may form subassemblies. Subassemblies may be formed, for example, by attaching components to a common printed circuit, by attaching components to a portion of housing 12, by attaching smaller components to the housing of a larger component, by joining components using brackets and supporting members, etc. A display subassembly may be formed by attaching components such as display module 28 (which may include an integral capacitive touch sensor formed from an array of transparent electrodes on display module 28), sensors 34 and 38, and sensor 62 to a support structure such as display cover layer 26.

The use of intermediate pre-assembled structures such as the display assembly and other subassemblies in device may facilitate volume manufacturing. Subassemblies can be manufactured in numerous potentially geographically remote facilities and tested before being assembled together to form a completed electronic device. If a fault is detected in a subassembly during manufacturing, the subassembly may be repaired or discarded without discarding the entire device.

The use of subassemblies may also facilitate repairs after a device has been shipped to an end user. If, for example, a user cracks display 14, the display assembly for the user's device may be replaced with a new display assembly. To ensure that the components of the subassembly are properly calibrated, calibration data for each subassembly may be stored in non-volatile memory or other storage on that subassembly as the subassembly is manufactured. When a display assembly is replaced, the control circuitry of the repaired device can retrieve the calibration data from the memory on the subassembly. This arrangement avoids or minimizes the need for performing complex calibration operations on repaired equipment. Such operations might otherwise require that a device be returned to a factory for calibration or might involve calibration using complex and costly equipment at a local service center.

The non-volatile memory that is provided for storing the calibration data may be mounted on a printed circuit within a subassembly or other substrate. As shown in the example of FIG. 2, non-volatile memory 46 for storing calibration data may be mounted one or more printed circuits in the display assembly of device 10 such as the flexible signal cables formed from flexible printed circuits 44, 52, 54, or 58. Non-volatile memory may, if desired, be incorporated into other integrated circuits in the display assembly (e.g., into part of a proximity sensor control circuit that is associated with sensor 38, part of a display driver circuit for controlling display module 28, part of a touch controller integrated circuit for handling touch signals for the touch sensor in display module 28, part of a fingerprint sensor control circuit associated with fingerprint sensor 62, or other integrated circuit that forms part of a display assembly or other subassembly in device 10).

If desired, calibration data may be stored remotely (e.g., on a server accessible through a wide area network such as the Internet). An identifier stored in memory 46 or elsewhere on the display assembly (or other subassembly) may then serve as a reference that allows device 10 or other equipment to look up and retrieve the remotely stored calibration data. For example, following calibration at a factory, calibration data for a display assembly may be stored in a database. The database calibration data for each display assembly may be tagged with one or more serial numbers or other subassembly identifier. When it is desired to repair a device with a damaged display, the display assembly for the device may be replaced. The device or other equipment may then retrieve the subassembly identifier from the non-volatile memory on the replacement display assembly or the subassembly identifier may be gathered using other techniques (e.g., bar code reading, etc.). Using this identifying information, the device or other equipment may retrieve the remotely stored calibration data from the database for use by the device.

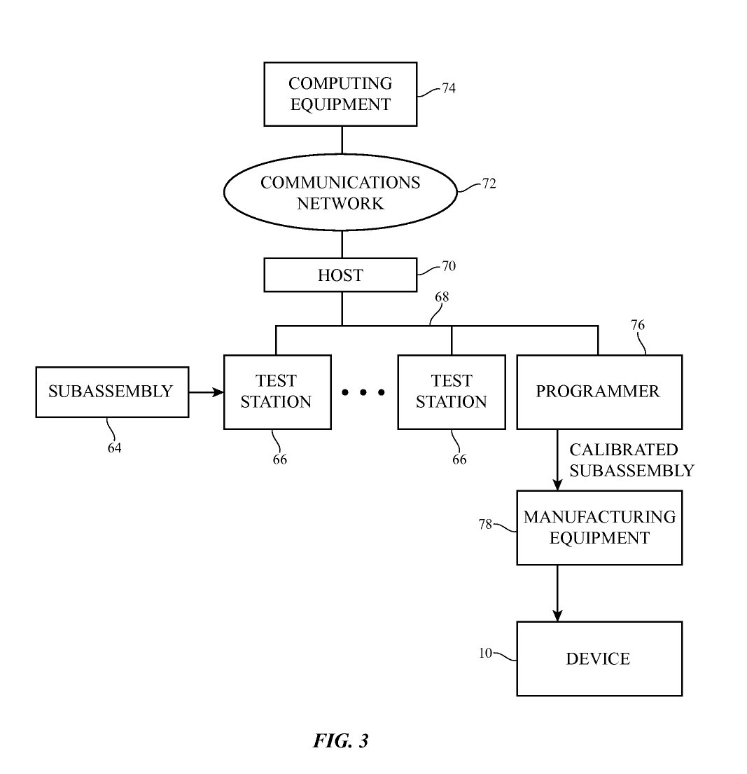

An illustrative system for calibrating device subassemblies such as a display assembly (display subassembly) is shown in FIG. 3. As shown in FIG. 3, a subassembly that has been manufactured such as subassembly 64 may be tested at one or more test stations 66. Test stations 66 may gather test results and may share these test results with host 70 over network 68. Host 70 (e.g., computing equipment such as one or more networked computers) may analyze the test results from test stations 66 and may produce corresponding calibration data for each of the electrical components in the subassembly.

Consider, as an example, a display assembly. Test stations 66 may include test equipment that calibrates ambient light sensor 36 (e.g., by measuring the sensitivity of sensor 36 to ambient light, by gathering angle-of-view sensitivity data for sensor 36, etc.). Test stations 66 may also include test equipment that calibrates proximity sensor 38 (e.g., to determine how much cross-talk may be present between source 40 and detector 42 due to variations in the placement of proximity sensor 38 relative to cover layer 26 and the window in opaque masking layer 38, by measuring the output of source 40 and the sensitivity of detector 42, etc.). The touch sensor in display module 28 may be calibrated for angular orientation, touch sensitivity (e.g., touch sensitivity variations induced by the placement of display module 28 on display cover layer 26 may be measured), etc. Test stations 66 may also calibrate the pixel array that displays images in display module 28 (e.g., for color fidelity, for brightness, for gray scale behavior, or other display characteristics). Fingerprint sensor sensitivity for sensor 62 may also be calibrated using test equipment such as equipment at one or more of test stations 66. During testing by test stations 66, the subassembly that is being calibrated (i.e., subassembly 64 of FIG. 3) may be mounted in one or more test fixtures, a dummy device housing, or other testing structures. The test results may be analyzed by host 70 or other equipment to produce calibration data (e.g., sensitivity values, offsets, or other information that can be used by the control circuitry of a device to ensure that the components of the subassembly perform properly when operated by a user).

In general, subassembly 64 may be any suitable assembly for incorporation into an electronic device. Subassemblies may be formed by mounting one or more electrical components (e.g., one component, two components, three components, four components, or five or more components) to one or more printed circuits and/or to other supporting structures to form a unitary subassembly structure. Examples of electrical components that may be included in a subassembly and which may be calibrated include input-output components such as buttons, joysticks, click wheels, scrolling wheels, touch pads, key pads, keyboards, microphones, speakers, tone generators, vibrators, cameras, sensors, gyroscopes, compasses, temperature sensors, moisture sensors, pressure sensors, force sensors, pulse oximeters, light-emitting diodes and other light sources, status indicators, data ports, displays, audio jacks and other audio port components, digital data port devices, light sensors such as ambient light sensors and other light sensors, fingerprint sensors, motion sensors (accelerometers), capacitance sensors, capacitive proximity sensors, light-based proximity sensors, other proximity sensors, touch sensors, touch screen displays, touch pads, capacitive buttons, sliding switches, rotary dials, storage components such as hard disk drive storage and other memory, integrated circuits such as one or more microprocessors, microcontrollers, digital signal processors, baseband processors, power management units, audio codec chips, application specific integrated circuits, surface mount technology (SMT) parts, discrete components such as inductors, capacitors, and resistors, electronic components such as switches, connectors, audio components, and other electrical components or combinations of any two or more of these components. These electrical components may be mounted in any combination (one or more of these components, two or more of these components, three or more of these components, etc.) to form any suitable type of subassembly 64 for device 10.

With one suitable arrangement, the calibration data for one or more components on a display subassembly or other subassembly 64 may be stored in one or more memory chips (see, e.g., non-volatile memory 46 of FIG. 2). Memory 46 may be stand-alone memory integrated circuit(s) or may be incorporated into one or more other integrated circuits in subassembly 64. Calibration data may, for example, be stored in memory 46 using programmer 76 (e.g., programmable-read-only memory programmer).

With another suitable arrangement, the calibration data that has been produced by host 70 may be uploaded to a remote storage location such as a database in computing equipment 74, which may be linked to host 70 through the Internet or other communications network 78. When uploading calibration data, the calibration data may be associated with a subassembly identifier such as serial number information (i.e., the subassembly identifier may be used to identify a database record for the calibration data). The subassembly identifier may also be stored in memory 46 or elsewhere on the subassembly for use in later retrieval of the calibration data that has been uploaded to computing equipment 74.

Calibrated subassemblies may be assembled together to form finished devices 10. Some calibrated subassemblies may be used as backups and may be retained for use in repairing devices that are accidentally damaged during use. For example, some calibrated display assemblies may be set aside for use in repairing cracked displays in otherwise good devices.

As shown in FIG. 3, manufacturing equipment 78 may be used in assembling subassemblies into finished electronic devices 10. Manufacturing equipment 78 may include robotic equipment and/or manually controlled manufacturing tools. When device 10 has been assembled, additional tests may, if desired, be performed using test equipment such as test stations 66. During use of device 10 (e.g., initial use during testing at the factory or subsequent use of the device by a user in the field), the control circuitry of device 10 (e.g., the microprocessor and other control logic implemented using components 32 on printed circuit 30) may retrieve the calibration data stored in memory 46. The retrieved calibration data may be used to calibrate device 10 and ensure that the components of the calibrated subassembly work satisfactorily. In scenarios in which the calibration data was stored remotely, the control circuitry may, at least initially, use a serial number or other subassembly identifier stored in memory 46 or elsewhere in the subassembly to retrieve the calibration data from the remote storage. The retrieved calibration data may then be stored locally (e.g., in non-volatile memory in components 32 or other control circuitry).

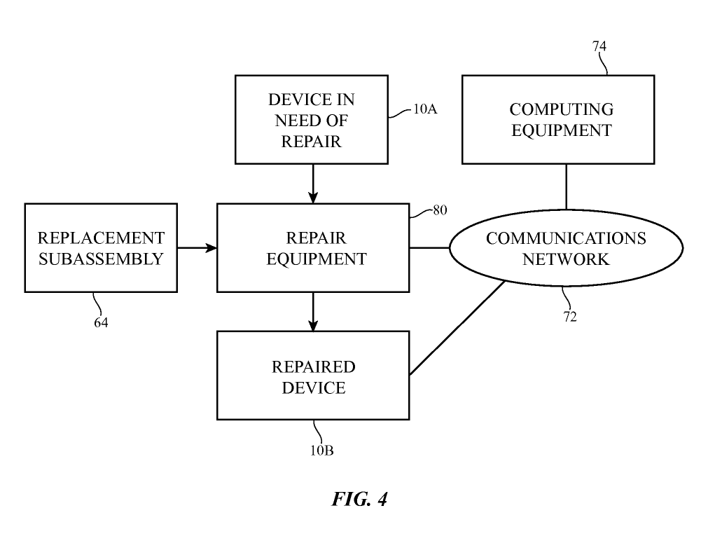

FIG. 4 is a diagram showing how an electronic device may be repaired after the device has been used by a user in the field. In a typical scenario, a user has an accident and drops the electronic device in water or against a hard surface. This may cause damage to a subassembly of the device. For example, display cover layer 26 in a display assembly may be cracked. To be able to provide rapid repairs for the user, it is desirable to be able to make local repairs in retail outlets or nearby service centers, rather than returning a device in need of repairs to a potentially distant manufacturing facility. It is generally impractical to outfit each of these service outlets with a full suite of factory test equipment (see, e.g., test stations 66 of FIG. 3). By storing calibration data in nonvolatile memory 46 and/or database on computing equipment 74 that is accessible over the Internet or other communications network as described in connection with FIG. 3, replacement subassemblies can be precalibrated before being shipped to service centers and the calibration data for the precalibrated subassemblies can be made available to device 10 upon repair. This avoids the need to return repaired devices to a factory test facility for calibration.

As shown in FIG. 4, replacement subassembly 64 may be installed within a device in need of repair such as device 10A using repair equipment 80. Repair equipment 80 may include automated equipment and/or manual assembly equipment. In a typical repair scenario, a faulty subassembly may be disconnected from a main logic board and other printed circuits 30 in device 10A by unplugging one or more printed circuit connectors. A precalibrated replacement subassembly that is in good working order may then be connected to the main logic board and other printed circuits by plugging one or more printed circuit connectors associated with the subassembly into one or more mating printed circuit connectors on the main logic board, thereby producing repaired device 10B.

When repaired device 10B powers up for the first time following replacement of the faulty subassembly with replacement subassembly 64, control circuitry in device 10B may obtain the previously produced calibration data corresponding to the replacement subassembly. The calibration data for a replacement display subassembly may include ambient light sensor calibration data, proximity sensor calibration data, fingerprint sensor calibration data, touch sensor calibration data, and display calibration data. Calibration data for different subassemblies may relate to the different collections of electrical components mounted on those subassemblies.

The control circuitry in repaired device 10B may obtain the calibration data from non-volatile memory 46 in the replacement subassembly. If desired, non-volatile memory 46 may be used to store a serial number or other subassembly identifier. Control circuitry in device 10B may obtain the subassembly identifier and may provide the subassembly identifier to a calibration data database such as a database implemented on computing equipment 74. The subassembly identifier may, as an example, be provided to computing equipment 74 as part of a calibration data request. The calibration data database can use the subassembly identifier to retrieve appropriate calibration data for the replacement subassembly (i.e., calibration data that was stored following initial calibration of the subassembly using test stations 66 of FIG. 3 in a manufacturing facility). The calibration data database may then return the requested calibration data for the replacement subassembly to the control circuitry in repaired device 10B over communications network 72. If desired, the control circuitry of device 10B may obtain calibration data for replacement subassembly 64 partly from local non-volatile memory 46 and partly from a remote database. Regardless of whether the calibration data is obtained from memory 46 or computing equipment 74, once the calibration data is received, device 10B can use the calibration data in performing operations with the components of the display assembly or other subassembly (i.e., the subassembly and device 10B will be calibrated and can make calibrated ambient light sensor measurements using ambient light sensor calibration data, can provide calibrated display output using display calibration data, can make calibrated proximity sensor measurements using proximity sensor calibration data, may make calibrated touch sensor measurements using touch sensor calibration data, and may make calibrated fingerprint sensor measurements using fingerprint sensor calibration data, etc.)

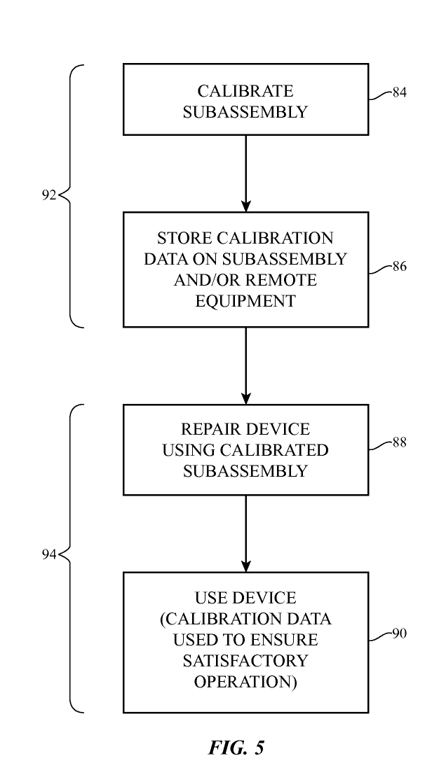

FIG. 5 is a flow chart of illustrative steps involved in precalibrating device subassemblies or other components (steps 92) and in using these precalibrated subassemblies in repairing a device (steps 94).

Device components (which are generally subassemblies but may also be single components such as a single sensor) may be calibrated during the operations of step 84. In particular, test equipment at one or more manufacturing facilities such as one of more of test stations 66 of FIG. 3 may be used in making test measurements and producing calibration data. It is not necessary for each component of a subassembly to be calibrated at the same location. Components may also be calibrated more than once. For example, a proximity sensor module may be calibrated at a proximity sensor manufacturing facility, whereas a fingerprint sensor may be calibrated at a fingerprint sensor manufacturing facility. Alternatively or in addition to these calibration measurements, proximity sensor and fingerprint sensor calibration measurements (as an example) may be made on these devices at a display assembly manufacturing facility. Manufacturing processes related to attachment and alignment of components on printed circuits and support structures such as display cover layer 26 may make it desirable to make at least some calibration measurements following incorporation of components into a subassembly. Moreover, it may be desirable to make at least some calibration measurements while a subassembly is mounted in a dummy electronic device housing or a jig that replicates pertinent features of the type of electronic device into which the subassembly will eventually be installed. By using some of all of these approaches, accuracy can be enhanced during calibration of subassemblies in manufacturing environments.

Following testing and analysis of test results to produce calibration data, the calibration data that has been obtained may be stored (step 86). The subassembly that is being calibrated may contain non-volatile memory 46, which may be loaded with calibration data using programmer 76 or other data storage equipment. With this type of approach, the calibration data may be carried with the subassembly for the life of the subassembly. The calibration data can be retrieved and used by control circuitry in a device in which the subassembly is installed, either during initial manufacturing of a fresh factory device or during subsequent field repairs on a device that has accidentally been damaged. To support remote calibration storage schemes, the operations of step 86 may, if desired, involve the uploading and storage of the calibration data for the subassembly at a remote database on computing equipment 74. The database may be located on a single server, may span multiple servers and/or geographic locations, may allow calibration data to be broken up into subsets and stored at common locations or different locations, etc. If desired, both local storage in memory 46 and remote storage may be used to maintain calibration data for a subassembly.

During use of an electronic device, a user may accidentally damage the device. For example, a display may become cracked during an unexpected drop event. The damaged electronic device may be repaired by swapping out the damaged display assembly or other damaged subassembly of the device for a factory calibrated subassembly (step 88).

After repairing electronic device 10 by installation of a replacement subassembly 64, control circuitry in the repaired device may obtain the calibration data for the replacement subassembly, thereby calibrating device 10 (step 90). Calibration data may be obtained by retrieving the calibration data from non-volatile memory 46 and/or by using a subassembly identifier in memory 46 to formulate a calibration data request for a remote database and storing the resulting calibration data that is provided to device 10 in storage in device 10. If desired, the control circuitry of device 10 may store the calibration data obtained from memory 46 and/or computing equipment 74 in additional non-volatile memory in device 10 (e.g., in control circuitry formed form components 32 of FIG. 2).

The foregoing is merely illustrative and various modifications can be made by those skilled in the art without departing from the scope and spirit of the described embodiments. The foregoing embodiments may be implemented individually or in any combination.

What is claimed is:

1. A subassembly for an electronic device, comprising:
a support structure;
electrical components mounted to the support structure; and
non-volatile memory that stores calibration data for the electrical components.

2. The subassembly defined in claim 1 wherein the support structure comprises a transparent display cover layer.

3. The subassembly defined in claim 2 wherein the electrical components comprise at least one component selected from the group consisting of: an ambient light sensor, a proximity sensor, a fingerprint sensor, a display, and a touch sensor.

4. The subassembly defined in claim 2 wherein the electrical components include a display module attached to the transparent display cover layer.

5. The subassembly defined in claim 4 wherein the electrical components include an ambient light sensor attached to the transparent display cover layer.

6. The subassembly defined in claim 5 wherein the electrical components include a proximity sensor having a light source and a light detector attached to the transparent display cover layer.

7. The subassembly defined in claim 6 wherein the electrical components include a fingerprint sensor attached to the transparent display cover layer.

8. The subassembly defined in claim 7 wherein the electrical components include a touch sensor attached to the transparent display cover layer.

9. An electronic device, comprising:
an electronic device housing;
a printed circuit to which control circuitry for the electronic device is mounted;
a display subassembly that is attached to the printed circuit with flexible printed circuit cables and that includes a plurality of electrical components; and
non-volatile memory on the display subassembly that stores calibration data for the plurality of electrical components, wherein the control circuitry obtains the calibration data through at least one of the flexible printed circuit cables.

10. The electronic device defined in claim 9 wherein the display subassembly comprises a transparent cover layer to which the electrical components are attached.

11. The electronic device defined in claim 10 wherein the electrical components include a display module that is attached to the transparent cover layer, wherein a given one of the flexible printed circuit cables is attached to the display module, and wherein the non-volatile memory is mounted on the given one of the flexible printed circuit cables.

12. The electronic device defined in claim 11 wherein the non-volatile memory is a stand-alone non-volatile memory integrated circuit.

13. The electronic device defined in claim 12 wherein the electrical components include an ambient light sensor mounted to the transparent cover layer and wherein the calibration data includes ambient light sensor calibration data for the ambient light sensor and display module calibration data for the display module.

14. The electronic device defined in claim 13 wherein the electrical components include a proximity sensor mounted to the transparent cover layer and wherein the calibration data further comprises proximity sensor calibration data for the proximity sensor.

15. The electronic device defined in claim 14 wherein the electrical components include a fingerprint sensor and wherein the calibration data comprises fingerprint sensor calibration data for the fingerprint sensor.

16. The electronic device defined in claim 15 wherein the electrical components include a touch sensor in the display module and wherein the calibration data comprises touch sensor calibration data for the touch sensor.

17. An electronic device that uses electrical component calibration data obtained from a remote database, the electronic device comprising:
an electronic device housing;
a printed circuit on which control circuitry is mounted;
a subassembly that is coupled to the printed circuit and that communicates with the control circuitry; and
non-volatile memory on the subassembly that stores a subassembly identifier identifying the subassembly, wherein the control circuit obtains the electrical component calibration data from the remote database using the subassembly identifier and stores the obtained electrical component calibration data to calibrate the subassembly.

18. The electronic device defined in claim 17 wherein the subassembly has a plurality of electrical components and wherein the calibration data stored by the control circuit includes calibration data for each of the plurality of electrical components.

19. The electronic device defined in claim 18 wherein the electrical components include:
a proximity sensor;
an ambient light sensor; and
a touch sensor.

20. The electronic device defined in claim 19 wherein the components include a display, wherein the subassembly includes a display cover layer, and wherein the display, the proximity sensor, the ambient light sensor, and the touch sensor are attached to the display cover layer.

21. A subassembly for an electronic device, comprising:
a support structure;
electrical components mounted to the support structure; and
non-volatile memory that stores calibration data for the electrical components, wherein the electrical components mounted to the support structure include at least two components selected from the group consisting of: buttons, touch pads, key pads, keyboards, microphones, speakers, tone generators, vibrators, cameras, gyroscopes, compasses, pressure sensors, force sensors, pulse oximeters, temperature sensors, moisture sensors, light-emitting diodes, light sensors, accelerometers, capacitance sensors, proximity sensors, fingerprint sensors, and touch sensors.
